(19) United States
(12) Patent Application Publication
(10) Pub. No.: US 2004/0158854 A1
(43) Pub. Date: Aug. 12, 2004

(54) Interactive remote control unit

(76) Inventors: Shinnosuke Nagasawa, Osaka (JP); Yasunobu Tsukio, Osaka (JP); Norifumi Sata, Hyogo (JP); Hiroshi Imada, Kyoto (JP)

Correspondence Address: RATNERPRESTIA, P O BOX 980, VALLEY FORGE, PA, 19482-0980, US

(21) Appl. No.: 10/775,867

(22) Filed: Feb. 10, 2004

(30) Foreign Application Priority Data
Feb. 10, 2003 (JP) 2003-032139
Sep. 12, 2003 (JP) 2003-321377

(51) Int. Cl. H04N 7/173; G06F 13/00; H04N 5/445; H04N 7/16; H04N 5/44

(52) U.S. Cl. 725/38; 348/734; 725/39; 725/131; 725/139

(57) ABSTRACT

An interactive remote control unit includes i) a receiver, ii) a display, iii) an entry section, iv) a transmitter, and v) a controller. The receiver receives a signal via a device to be controlled; the display shows information carried by the signal; the entry section accepts a viewer's request with respect to the information on the display; the transmitter, according to the request at the entry section, transmits operation data for controlling the device; and the controller governs all of the components above. Such structured remote control unit can offer an electronic program guide service and other services, introducing them not on the TV display but on the display of the unit on hand. In the case that the unit is employed for interactive communications with a camera, the unit allows a user to control the camera from a distance.

### FIELD OF THE INVENTION

The present invention relates to an interactive remote control unit to communicate bi-directionally with a device to be controlled.

### BACKGROUND ART

As digital communications technology progresses, digital broadcasting services have been available. In the service, video, audio, and data signals for broadcasting are integrally processed and exchanged via a communications satellite and the like. Besides, improvement in compression multiplexing technology, such as a standard developed by the Moving Picture Experts Group (MPEG), allows viewers to have TV programs seen on multi channels. In response to such a technology, an electronic program guide (EPG) service is already in use, by which a viewer can easily select a favorite program from a variety of programs.

The EPG service provides viewers with, for example, the title of a TV program or program to be televised, a TV station name, brief introduction of a program and a performer in the program. The EPG service also provides viewers with useful functions—searching for a program to be televised, and easy pre-setting of video to record a favorite program. Referencing to the EPG information being shown on the TV screen, a viewer operates a remote control unit to list TV programs on the screen, search a program, or pre-set a video for recording a program. Other than the EPG service, various services have recently been available; viewers can enjoy such services via a remote control unit. For example, Japanese Patent Non-examined Publication No. H10-271359 introduces the aforementioned technology.

In utilizing the EPG service or other services via a conventional remote control unit, however, a viewer has to display an information guide on a service on the TV screen prior to program selection. That is, the information guide shown on the screen interrupts the program that the viewer has been watching. The area used for introducing a service can be limited in a part of the TV screen; still, some viewers may be irritated by a messy display.

In addition, video-on-demand (VOD) services have recently been available. The VOD service is a bi-directional multimedia service by which a viewer can watch his/her desired program at a convenient time via interactive operations, such as selecting a program, and starting, stopping, or fast-forwarding the program. This is completely different from the conventional TV broadcasting system, where all the programs go on along the broadcasting schedule.

Before using such a service, a viewer needs to know what kinds of programs are provided by the service. Firstly, the viewer makes access to a program preview-dedicated channel to preview a program on the TV screen. Even after selecting a favorite program, the viewer has to access to a sign-up window and complete the selection via the TV screen.

The conventional service requires a complicated procedure—a viewer has to select a desired program among a wide variety of channels.

Furthermore, when obtaining pay program information, such as a newly arrived movie, a viewer faces an inconvenience of making periodic access to the pay program-dedicated channel to get program information. The troublesome procedure often saps the consumption interest from the viewer. On the other hand, an information provider cannot give the latest information until a viewer makes an access to the channel. Showing all the time the program information on the TV screen may be a solution. However, like in the case of aforementioned EPG service, some viewers may be annoyed with the messy screen.

### SUMMARY OF THE INVENTION

The interactive remote control unit of the present invention contains i) a receiver; ii) a display; iii) an entry section; iv) a transmitter; and v) a controller. The receiver receives a signal via a device to be controlled. The display shows information on the signal captured at the receiver. The entry section accepts viewer's input with respect to the information shown on the display. The transmitter outputs operation data for governing the device to be controlled, according to the input data entered through the entry section. The controller controls the receiver, the display, and the transmitter.

### BRIEF DESCRIPTION OF THE DRAWINGS

FIG. 1 shows a block diagram in the case that the interactive remote control unit of an exemplary embodiment of the present invention is employed for a digital-broadcasting receiver.

FIG. 2 is a flow chart illustrating data exchange between the digital-broadcasting receiver and the interactive remote control unit through interactive communications in the process of displaying for an electronic program guide (EPG) or broadcasting programs.

FIG. 3 is a flow chart illustrating the procedures of transmitting the EPG data by the digital-broadcasting receiver.

FIG. 4 is a flow chart illustrating the procedures of displaying the EPG on the interactive remote control unit.

FIG. 5 is a flow chart illustrating the procedures of transmitting broadcasting program data by the digital-broadcasting receiver.

FIG. 6 is a flow chart illustrating the procedures of displaying the broadcasting program on the interactive remote control unit.

FIG. 7 shows a screen layout of the interactive remote control unit.

FIG. 8 is a screen layout in which a coupon ticket is shown of the interactive remote control unit.

FIG. 9 is a screen layout in which a map is shown on the interactive remote control unit.

FIG. 10 shows a block diagram in the case that the interactive remote control unit of an exemplary embodiment of the present invention is employed for a recording/reproducing device.

FIG. 11 is a flow chart illustrating the procedures of data exchange between the recording/reproducing device and the interactive remote control unit through interactive communications in the process of displaying contents data and contents motion picture data.

FIG. 12 is a schematic diagram indicating a screen layout of the interactive remote control unit.

FIG. 13 is a block diagram of another interactive remote control unit of an embodiment of the present invention.

FIG. 14 is a flow chart illustrating the workings of the interactive remote control unit of an embodiment of the present invention.

FIG. 15 is a schematic diagram of still another interactive remote control unit of an embodiment of the present invention.

FIG. 16 is a block diagram in the case that the interactive remote control unit of an exemplary embodiment of the present invention is employed for a camera.

### DETAILED DESCRIPTION OF THE INVENTION

The exemplary embodiments of the present invention are described hereinafter with reference to the accompanying drawings. Through the embodiments, similar reference marks indicate like parts in the appended drawings when the structure of an embodiment is the same as that of a preceding embodiment, and the detailed description thereof will be omitted.

### FIRST EXEMPLARY EMBODIMENT

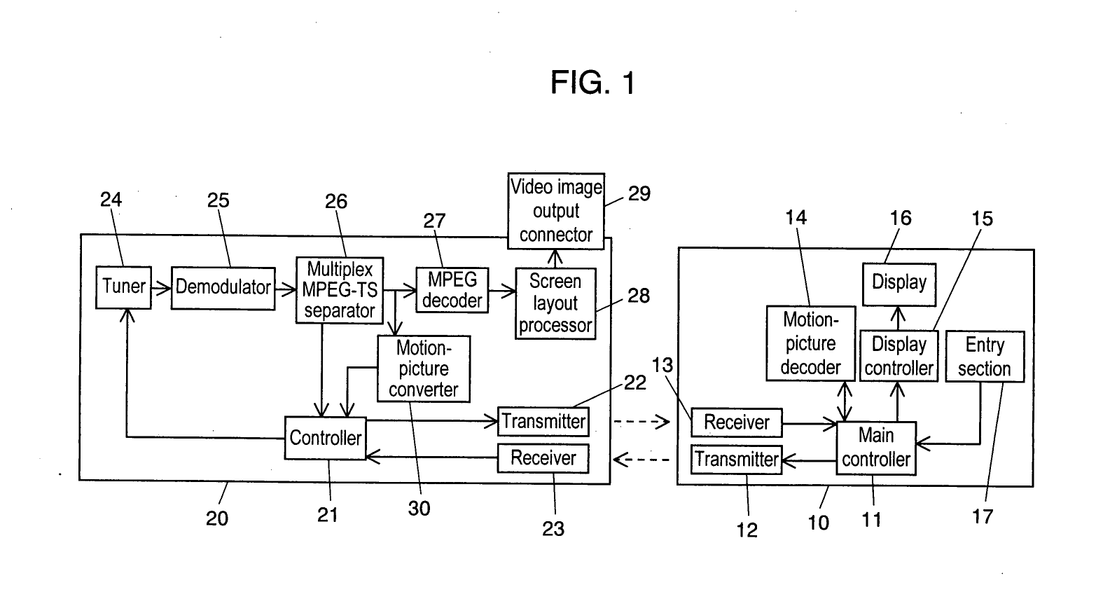

FIG. 1 shows a block diagram in the case that an interactive remote control unit of an exemplary embodiment of the present invention is employed for a digital-broadcasting receiver. Interactive remote control unit (hereinafter referred to as remote controller) 10 of the embodiment controls a device to be controlled, i.e., digital-broadcasting receiver (hereinafter, receiver) 20 through bi-directional wireless communications.

Remote controller 10 contains receiver 13, transmitter 12, motion-picture decoder (hereinafter, decoder) 14, display 16, display controller 15, entry section 17, and main controller 11. Receiver 13 receives signals including electronic program guide (EPG) data and broadcasting program data, and transmitter 12 transmits information on operating receiver 20. Decoder 14 decodes the broadcasting program data including motion pictures handed from receiver 13. Display 16 shows the information received at receiver 13, i.e., EPG data and broadcasting program data, or graphical user interface (GUI) for controlling remote controller 10. Display controller 15 controls display 16. Entry section 17 is formed of, for example, a plurality of entry keys or a touch panel, with which a viewer enters input data. Main controller 11, which is the CPU of remote controller 10, governs whole sections described above.

Receiver 20 includes the following sections: tuner 24; demodulator 25; multiplex MPEG-TS separator (hereinafter, separator) 26; MPEG decoder 27; screen layout processor (hereinafter, processor) 28; video image output connector (hereinafter, connector) 29; motion-picture converter (hereinafter, converter) 30; transmitter 22; receiver 23; and controller 21. Tuner 24 selectively receives a broadcasting signal, and demodulator 25 demodulates the broadcasting signal handed from tuner 24. Separator 26 separates a multiplex MPEG-TS signal into each individual signal, and MPEG decoder 27 decodes an MPEG signal. Processor 28 creates a display screen in which such as motion pictures, graphics and text are combined. Connector 29 outputs a video signal to a TV set. Converter 30 changes the MPEG signal into a signal in a format to be accepted by remote controller 10. Transmitter 22 transmits EPG data and broadcasting program data, and receiver 23 receives operation data. And all of the sections above are under control of controller 21, which is the CPU of receiver 20.

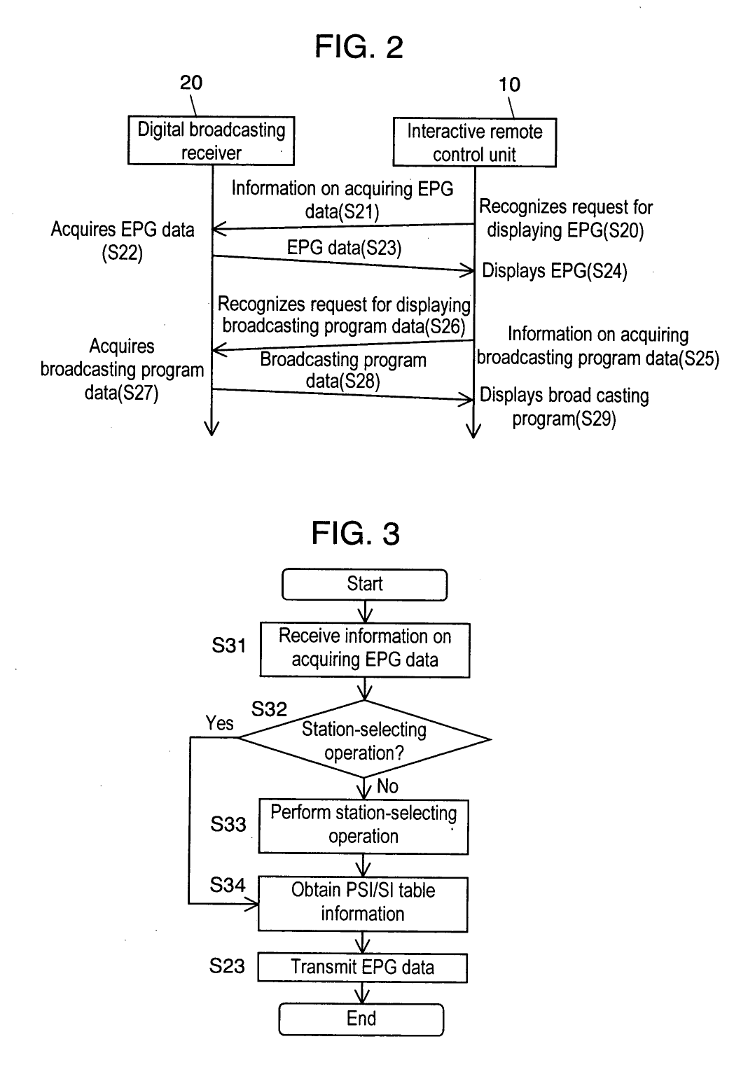

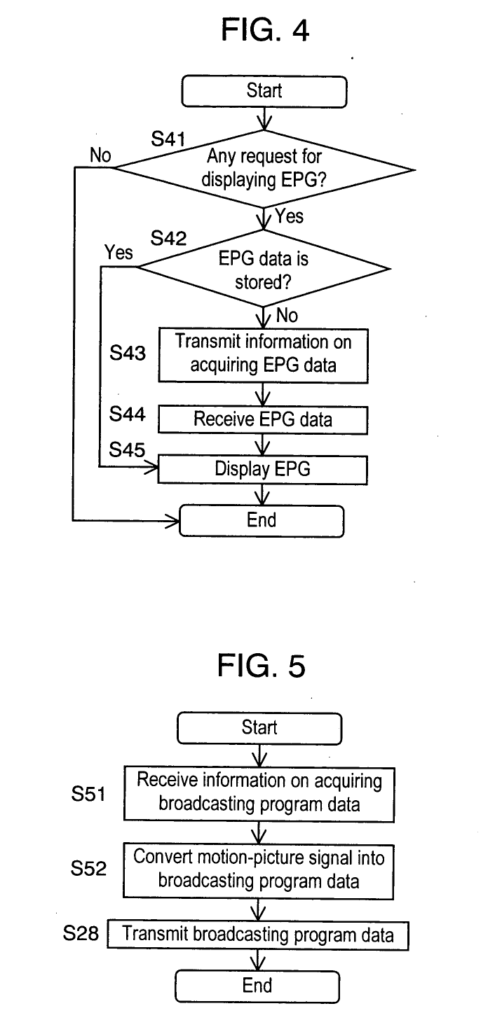

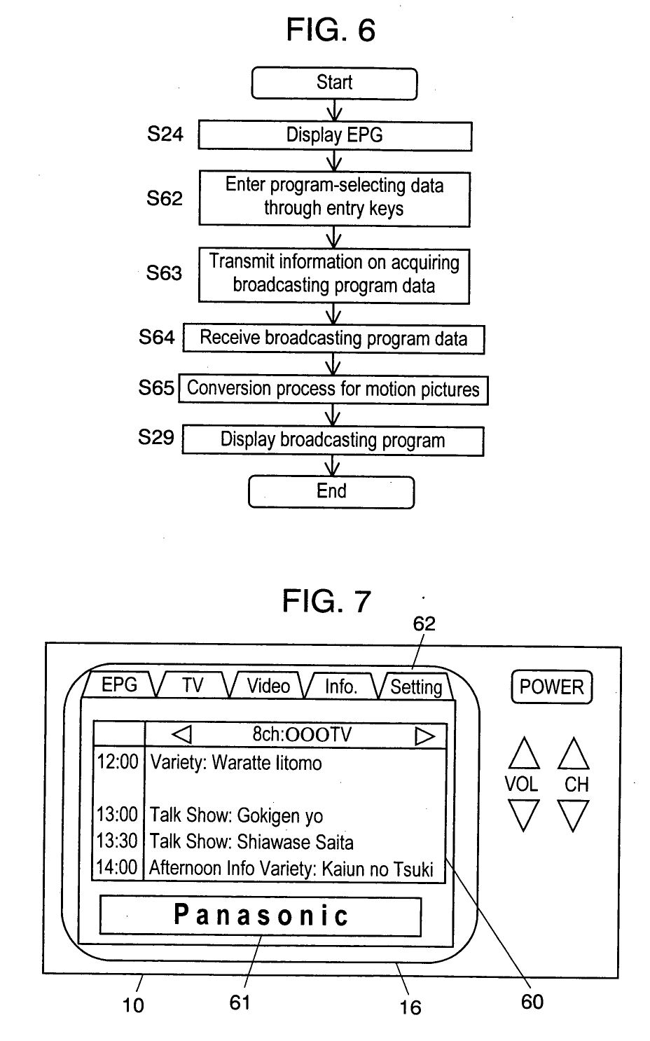

With such structured remote controller 10 and receiver 20, now will be described the procedures of showing an EPG or a broadcasting program on display 16 of remote controller 10, with reference to FIG. 1 through FIG. 5. FIG. 2 is a flow chart illustrating data exchange between receiver 20 and remote controller 10 through interactive communications in the process of displaying an EPG or a broadcasting program. FIG. 3 is a flow chart illustrating the procedures of transmitting EPG data by receiver 20. FIG. 4 is a flow chart illustrating the procedures of displaying the EPG on remote controller 10. FIG. 5 is a flow chart illustrating the procedures of transmitting broadcasting program data by receiver 20. FIG. 6 is a flow chart illustrating the procedures of displaying a broadcasting program on remote controller 10.

Entry section 17 carries a key-input signal or a touch panel-input signal as a request entered by a viewer to main controller 11. Main controller 11 recognizes the request for displaying an EPG with the timing any one of when i) the power is turned on; ii) a key-input signal or a touch panel-input signal from entry section 17 comes in; and iii) a predetermined time interval is expired, (which corresponds to S20 in FIG. 2.) Main controller 11 sends information on acquiring EPG data to transmitter 12. Receiving the information, transmitter 12 converts it into a radio-frequency (RF) signal and transmits the signal to receiver 23 of digital-broadcasting receiver 20 (S21).

Receiver 20 acquires EPG data, according to the RF signal received by receiver 23 (S22). The EPG data is formed of program arrangement information required for creating an EPG, and a still image for the EPG. Turning to FIG. 3, in S31, controller 21 receives information on acquiring EPG data from remote controller 10. In S32, controller 21 checks whether receiver 20 is in the operation of selecting stations. If receiver 20 is in the selecting operation, the procedure goes to S34; otherwise, controller 21 performs station-selecting operation and then goes to S34. In S34, controller 21 obtains, from separator 26, PSI/SI table information including the EPG data, according to the information on acquiring EPG received in S31.

Controller 21 hands the EPG data to transmitter 22 based on the PSI/SI table information. In 23, receiving the data from controller 21, transmitter 22 converts the data into an RF signal and sends the signal to receiver 13 of remote controller 10.

In remote controller 10, on the other hand, main controller 11 finds the EPG data in the RF signal received by receiver 13. According to the EPG data, main controller 11 creates an EPG window and sends it display controller 15. Controller 15 requests display 16 to show the EPG window (S24).

Here will be described details on the aforementioned working of remote controller 10 with reference to FIG. 4. In S41, main controller 11 checks on the presence or absence of display request for an EPG from input operations at entry section 17 by a viewer. In S42, if a display request is found, main controller 11 further checks whether data on an EPG is stored or not in remote controller 10. If remote controller 10 retains the EPG data, main controller 11 sends it to display controller 15 to show on display 16 (S45). If remote controller 10 has no EPG data, controller 11 sends information on acquiring EPG data to receiver 20 (S43). As described above, main controller 11 obtains an EPG data in S44, and sends the EPG data to display 16 through display controller 15 in S45 to show an EPG window.

Referencing to the EPG window shown on display 16, a viewer enters request for displaying a broadcasting program through the entry keys or the touch panel of entry section 17, and the input signal is carried to main controller 11. That is, as is shown the data flow of S25 in FIG. 2, a request for displaying a broadcasting program is generated. In response to the request, main controller 11 sends information on acquiring broadcasting program data to transmitter 12. In S26, transmitter 12 converts the information into an RF signal, and transmits it to receiver 20.

Receiver 20, on the other hand, obtains the content, i.e., the broadcasting program data according to the RF signal received by receiver 23 in S27. A detailed explanation will be given with reference to FIG. 5. In S51, controller 21 receives the information on acquiring broadcasting program data from remote controller 10. Controlling tuner 24, controller 21 selects a broadcasting signal including the broadcasting program data requested by the viewer, i.e., an MPEG-TS signal. In S52, the MPEG-TS signal is converted at converter 30 to prepare a broadcasting program data. Controller 21 transmits the broadcasting program data to transmitter 22. Receiving the program data, transmitter 22 converts it into an RF signal and sends the signal to receiver 13 of remote controller 10 in S28.

In remote controller 10, on the other hand, main controller 11 receives the broadcasting program data from the RF signal received at receiver 13 and sends it to decoder 14, where a motion picture data for the broadcasting program is obtained. The motion picture data is sent to display controller 15, and is displayed on display 16 in S29.

Here will be described details on the aforementioned working of remote controller 10 with reference to FIG. 6. Referencing to the EPG window shown on display 16 in S24, a viewer enters program-selecting data through the entry keys or the touch panel of entry section 17 in S62. Main controller 11 transmits, through transmitter 12, information on acquiring a broadcasting program data to receiver 20 in S63. Responding to the transmission, receiver 20 sends an RF signal back to receiver 13 in S64. The RF signal is carried, through main controller 11, to decoder 14 for converting the signal into a motion picture data for a broadcasting program in S65. The motion picture data is further sent to display controller 15 and then shown on display 16 in S29.

According to the embodiment, as described above, responding to the viewer's input operation with remote controller 10, receiver 20 selects data on an EPG or a broadcasting program from broadcasting signals and sends the data back to remote controller 10. Receiving the data, remote controller 10 shows an EPG, a broadcasting program, or a combination of them on display 16. Such a structure allows remote controller 10 to be user-friendly.

Although the embodiment introduces the case in which a common broadcasting program including a motion picture is received, it is not limited thereto; the structure is applicable to receiving teletext broadcasting or data broadcasting. In those cases, receiver 20 sends a signal containing table-of-contents data and broadcasting program guide data, and the contents include data on the main body of a document and motion pictures for the data-broadcasting program.

Here will be described display examples on display 16. FIG. 7 through FIG. 9 show examples of screen layout of remote controller 10. Remote controller 10 is formed of display 16 having a touch panel and one or more buttons for key input. Aforementioned touch panel and buttons configure entry section 17.

Display 16 shows various kinds of tabs 62: an EPG tab for showing an EPG; a TV tab for a broadcasting program; a video tab for a video motion picture; an Info. tab for showing service information with or without charge; and a system-setting tab for setting a communication parameter, a display parameter, and so on. Providing tabs 62 allows a viewer to lead various tab-linked sub windows including different contents. That is, disposing tabs enables display 16 to bear a lot of information.

The EPG tab-linked screen contains, as shown in FIG. 7, i) EPG 60 and ii) ads information 61, which is formed of text data, a still image, a motion picture, or a combination of them. A viewer can select ads information 61 to obtain the details on it. Besides, the display of ads information 61 can be masked by setting in the sub-window led by system-setting tab 62.

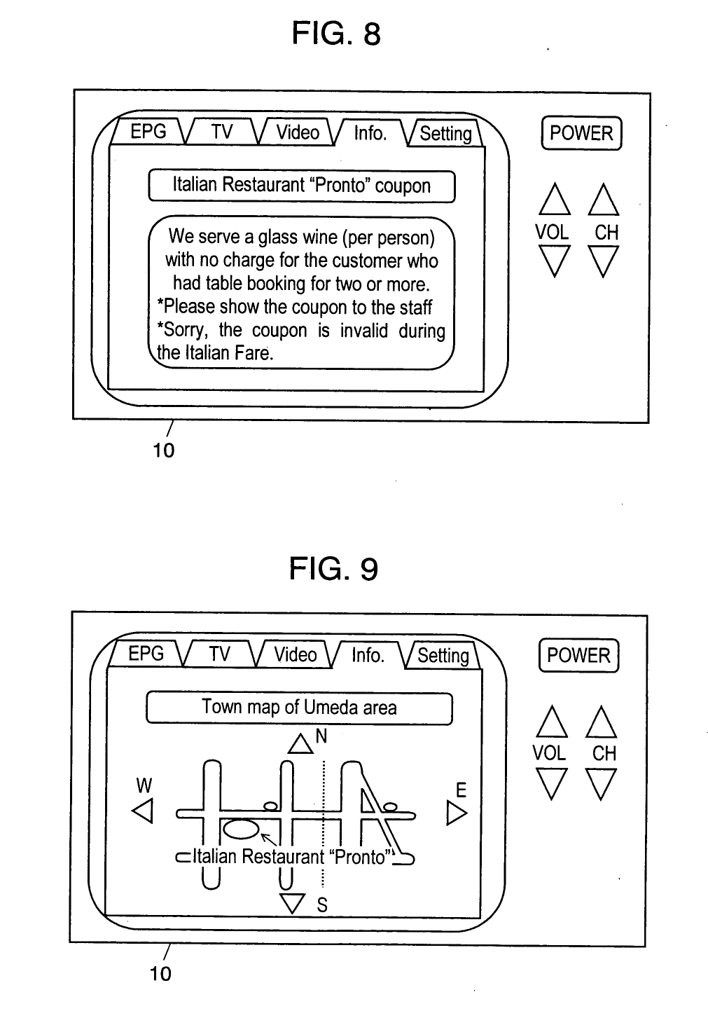

Each display 16 of remote controller 10 in FIG. 8 and FIG. 9 shows a coupon ticket and a map, respectively, both of which may be charged service information, or no-charge service information.

By operating remote controller 10, the display of ads information can be shrunk in a limited area or spread all over the area of display 16; can be masked; or can be periodically or continuously shown on display 16. A viewer can also operate the unit to show charged service information or no-charge service information on display 16. With such structured interactive remote control unit of the embodiment, a viewer can obtain useful information in addition to the function of a conventional remote control unit. On the other hand, an information provider can provide viewers with ads information in an inconspicuous but effective way.

### SECOND EXEMPLARY EMBODIMENT

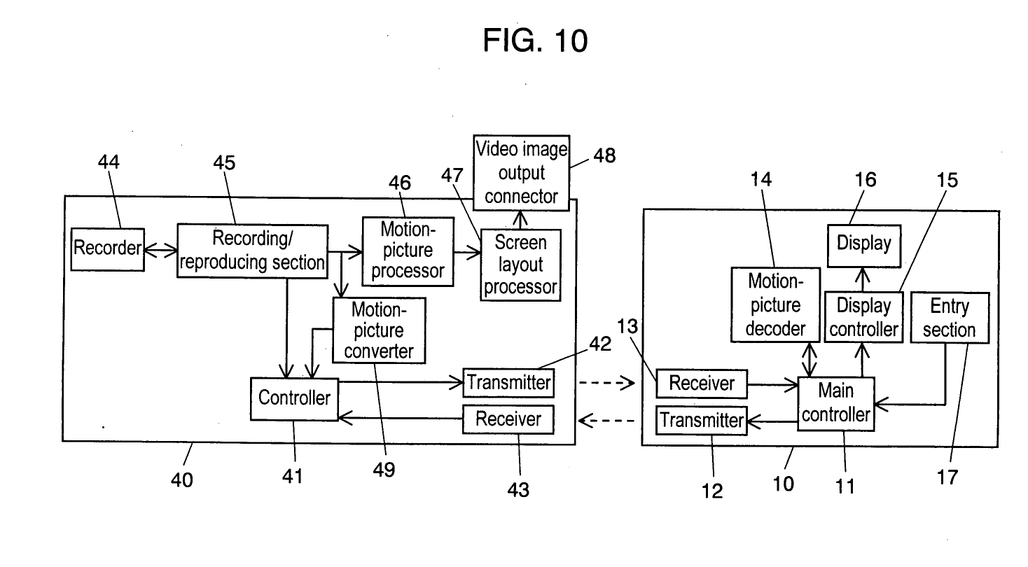

FIG. 10 shows a block diagram in the case that an interactive remote control unit of an exemplary embodiment of the present invention is employed for a recording/reproducing device. In this embodiment, interactive remote control unit (hereinafter, remote controller) 10 controls a device to be controlled, i.e., recording/reproducing device 40 through interactive communications.

In remote controller 10, receiver 13 receives a signal including contents information and data on contents motion picture. Motion-picture decoder (hereinafter, decoder) 14 decodes the contents motion picture image received by receiver 13. Display 16 shows table-of-contents information and contents motion picture, which are prepared according to the signal received at receiver 13, i.e., contents information, and also shows graphical user interface (GUI) for controlling remote controller 10. The rest of components of remote controller 10 are the same as those of the structure described in the first embodiment.

Recording/reproducing device 40 contains a) recorder 44, b) recording/reproducing section 45, c) motion-picture processor 46, d) screen layout processor 47, e) video image output connector (hereinafter, connector) 48, f) motion picture image converter (hereinafter, converter) 49, g) transmitter 42, h) receiver 43, and i) controller 41 for controlling whole components above. Recorder 44 records data on contents motion picture data to a recording medium. Making an access to recorder 44, recording/reproducing section 45 writes the contents motion picture data into a medium, or reads data from the medium. Motion-picture processor 46 reproduces the contents motion picture. Screen layout processor 47 creates a screen on which a motion picture, graphics, and text are overlaid. Connector 48 outputs a video signal to a TV set. Converter 49 obtains the contents motion picture data from recording/reproducing section 45 and converts the data into a suitable form for transmission to remote controller 10. Transmitter 42 transmits contents information which is a table of contents of motion pictures, and the contents motion picture data. Receiver 43 receives operation data. Controller 41 is the CPU of remote controller 10. Such structured recording/reproducing device 40 may be a videocassette recorder, a hard disk video recorder, or an optical disk video recorder.

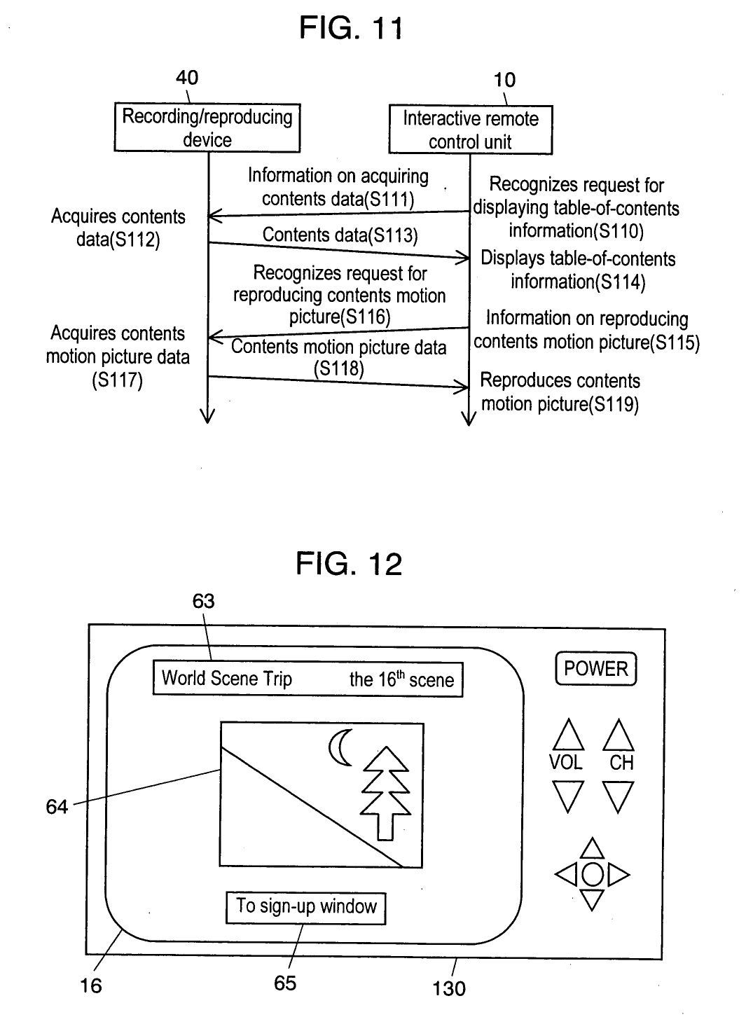

With such structured recording/reproducing device 40 and remote controller 10, now will be described the process to showing contents information or contents motion picture on display 16 of remote controller 10, with reference to FIG. 10 and FIG. 11. FIG. 11 is a flow chart illustrating procedures of data exchange between recording/reproducing device 40 and remote controller 10 through interactive communications in the process of displaying contents information and contents motion picture.

Entry section 17 carries a key-input signal or a touch panel-input signal as a request entered by a viewer to main controller 11. Main controller 11 recognizes the request for displaying table-of-contents information with the timing any one of when i) the power is turned on; ii) a key input signal or a touch panel input signal from entry section 17 to display table-of-contents information comes in; and iii) a predetermined time interval is expired (S110). Main controller 11 sends information on acquiring contents to transmitter 12. Receiving the information, transmitter 12 converts the information into a radio-frequency (RF) signal and transmits the signal to receiver 43 of recording/reproducing device 40 (S111).

Meanwhile, in recording/reproducing device 40, controller 41 receives data on acquiring contents information from remote controller 10, according to the RF signal captured by receiver 43. Through the process, controller 41 acquires contents information from recording/reproducing section 45 (S112). Controller 41 further sends the information to transmitter 42. Transmitter 42 converts the contents information into an RF signal and transmits the signal to receiver 13 of remote controller 10 (S113).

In remote controller 10, on the other hand, main controller 11 reads contents information from the RF signal received by receiver 13. Main controller 11 generates a table-of-contents window with reference to the contents information and sends the window, through display controller 15, to display 16 (S114).

Referencing to the table-of-contents window on display 16, a viewer enters a request on reproducing contents motion picture through the entry keys or the touch panel of entry section 17, and the input signal is carried to main controller 11. That is, a request for reproducing contents motion picture comes in main controller 11 with the timing of the input operations by the viewer (S115). In response to the request, main controller 11 sends information on reproducing contents motion picture to transmitter 12. Transmitter 12 converts the information into an RF signal, and transmits the signal to recording/reproducing device 40 (S116).

In recording/reproducing device 40, on the other hand, controller 41 obtains information on reproducing contents motion picture from remote controller 10 according to the RF signal received at receiver 43. Controller 41 reads out, through recording/reproducing section 45, the contents motion picture data requested by the viewer. Converter 49 converts contents motion picture signal into contents motion picture data (S117). Controller 41 sends the data to transmitter 42. Receiving the data from controller 41, transmitter 42 converts it into an RF signal and transmits the signal to receiver 13 of remote controller 10 (S118).

In remote controller 10, on the other hand, according to the RF signal received at receiver 13, main controller 11 receives the data on contents motion picture and sends the data to decoder 14, where contents motion picture is obtained. The contents motion picture is now sent to display controller 15, and is displayed on display 16 (S119).

According to the embodiment, as described above, responding to the viewer's input operation with remote controller 10, recording/reproducing device 40 transmits contents information or contents motion picture data to remote controller 10. Receiving the data, remote controller 10 shows table-of-contents information, contents motion picture, or a combination of them on display 16. Such a structure provides remote controller 10 with highly user-friendly functions.

As is described in the first embodiment, tabs can be arranged in display 16.

### THIRD EXEMPLARY EMBODIMENT

The third embodiment introduces the interactive remote control unit described above with which a viewer can further enjoy a video-on-demand (VOD) service comfortably. Interactive remote control unit (hereinafter, remote controller) 130 of the embodiment shows program information provided by the VOD service in response to viewer's operations on display 16.

Such structured remote control unit allows a viewer to obtain the up-to-the-minute program information with ease. Furthermore, a viewer can easily make an access to a sign-up window for applying for a VOD service on the side of the TV screen. The easy accessibility arouses the willingness to pay of viewers. At the same time, information providers can achieve the increase in the number of visitors to the window—despite of one-way information delivery—by virtue of the easy accessibility.

Here will be described details of the embodiment with reference to the accompanying drawings. FIG. 12 is a schematic view showing the screen layout of remote controller 130. Display 16, which is formed of liquid crystal display and a touch panel, shows program title 63, motion picture information 64 of the program, touch-box 65 to lead a viewer to the sign-up window for applying the program. In the case that touch-box 65 is located in the touch panel, touch-box 65 belongs to entry section 17.

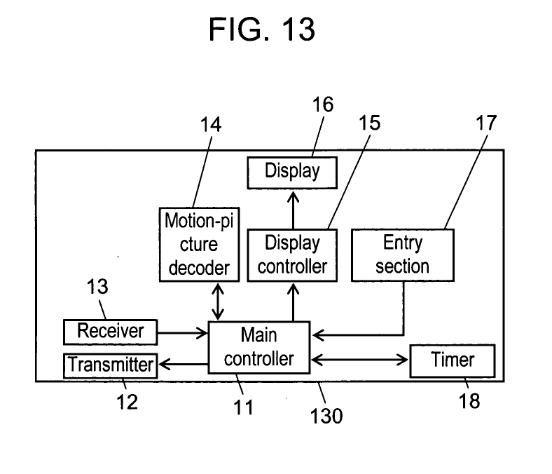

FIG. 13 is a block diagram of remote controller 130. Remote controller 130 of the embodiment has a basic structure in which timer 18 is added to remote controller 10 described other embodiments. For the rest, remote controller 130 is the same as remote controller 10.

According to the embodiment, remote controller 130 is so designed that a simple motion of touching the body of the unit allows promotional program information from providers to be automatically received and shown on display 16. That is, remote controller 130 has a touch sensor, which is a part of entry section 17, on the surface of the unit. As another possible structure, the receipt and display of the information may be triggered by viewer's operations on the touch panel or the keys. Such a setting can be changed or canceled as necessary, which allows the remote control unit to be user-friendly.

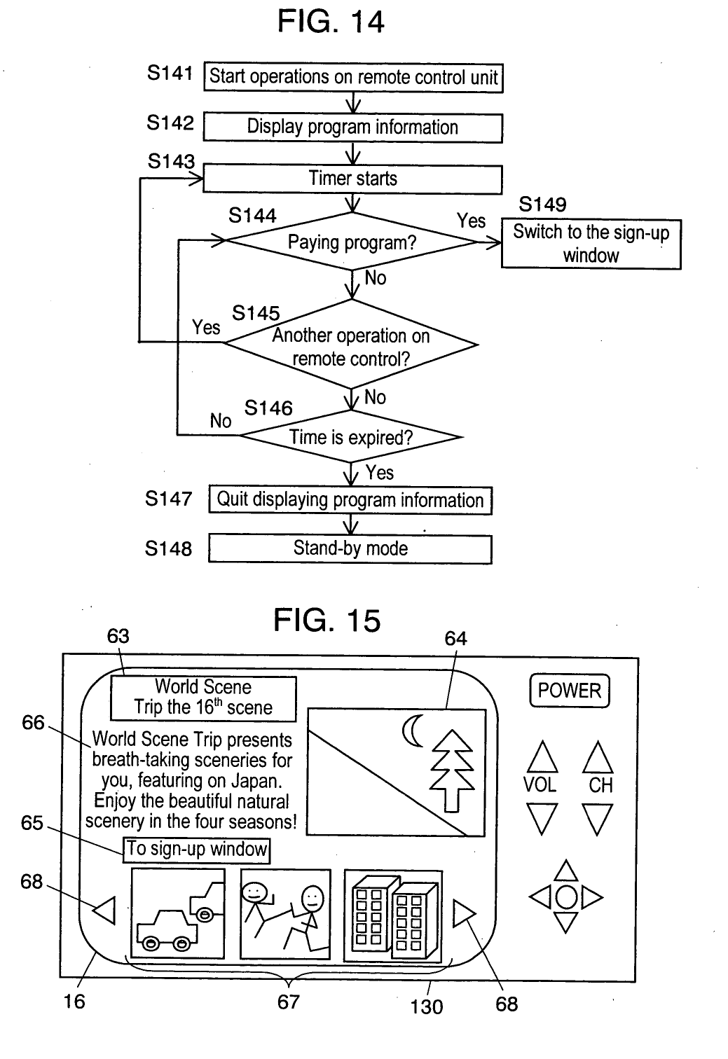

Now will be described how remote controller 130 works with reference to FIG. 14. FIG. 14 is a flow chart illustrating the workings of remote controller 130.

In response to viewer's operation on remote controller 130 (S141), display 16 automatically shows program information (S142). At the same time, timer 18 starts as an elapsed-time counter (S143). In S144, if the viewer finds his/her favorite program on the display, or interested in more detailed information, the viewer touches touch box 65 to switch the window to the sign-up window or the window having details of the program requested (S149). Having touch-box 65 in the display easily leads the viewer to the sign-up window.

On the other hand, in S144, if the viewer has no interest in the program information, that is, no operation on touch-box 65 is done, the procedure goes to S 145, where the viewer is prompted for the request for showing program information in the next page. If the unit recognizes the request from the viewer, the procedure goes back to S143, where timer 18 is reset and the viewer is again prompted for operations.

If the viewer's response fits neither of above—no sign-up and no requesting, timer 18 is checked whether the predetermined time set at S143 is expired or not (S146). If the predetermined time is not expired, the procedure goes back to S144 to show another program information; otherwise, that is, if timer 18 tells the expiration of the preset time, display 16 ceases from showing the program information (S147). Remote controller 130 goes into stand-by mode, with display 16 being blanked (S148). As described above, remote controller 130 terminates the display at the conclusion of a predetermined period of time elapsed since display 16 has shown the information, or since the viewer's last operation on the unit. With the structure, remote controller 130 can minimizes the power consumption.

In the program information of the VOD service shown in display 16, when the display of program information including a motion picture completes, display 16 switches the window to other program information. Remote controller 130 can thus provide the viewer with the latest program information. As another possibility, remote controller 130 may have a structure in which the display is forcefully switched to another program information according to the intention of a contents provider. Such a structure arouses the viewer's interest in another program.

FIG. 15 is a schematic view illustrating the screen layout of remote controller 130. Display 16, as is in FIG. 15, shows not only a motion picture, but also combination of a motion picture, still image, and text data. Here will be described an example of the display layout and the workings of the unit, with reference to FIG. 15. Display 16 includes i) program title 63, ii) touch-box 65 for leading a viewer to the sign-up window, iii) motion-picture window 64, iv) text window 66, v) still image window 67, and vi) scroll up/down buttons (hereinafter, buttons) 68 for still image window 67 or the like. Buttons 68 belong to the touch panel, forming a part of entry section 17.

In response to the viewer's operations on the remote controller 130, a screen, just like shown in FIG. 15, appears on display 16. In motion-picture window 64, an animated preview automatically starts. When a preview for a certain program completes, a different preview introducing another program begins. When the viewer operates buttons 68, the still image shown in window 67 is switched to another ones. The viewer can watch the preview of any program by using touch-panel functions in display 16. Suppose that the viewer is interested in a program and want to sign-up for applying the program to see preview, still image or text data. In this case, touching on touch-box 65 leads the viewer to the sign-up window. In this way, the viewer can unconsciously and easily obtain the most up-to-date program information with no use of the TV screen. Such an easy operation on the remote control unit automatically increases the chance of viewer's access to the VOD service, thereby facilitating the sign-up for applying programs.

Besides, such structured screen can provide a viewer with more explicit information. When a viewer operates buttons 68 and selects a program by watching still image 67, the animated preview corresponding to the program starts in motion picture window 64. The clearly visualized structure further arouses viewer's interest in contents.

Display 16 may have a structure in which the motion-picture window, the text window, and the still image window are put on one after another. Such a screen layout can save the area of display 16.

The easy operations on remote controller 130 allow a viewer to have more detailed information on VOD programs through display 16. Furthermore, the information can be immediately transmitted to a VOD program screen of a TV set controlled by remote controller 130. This allows a viewer to acquire program information, driving the viewer to pay.

When watching a motion picture on remote controller 130, the viewer can use mute control as required—when watching another program on the TV screen, the viewer can mute sound of a motion picture on remote controller 130. The mute control keeps the viewer watching the TV from being discomfort. Such a structure with the mute function can be applied to the structures described in the first and second embodiments to have the same effect.

In addition, remote controller 130 can be structured so as to acquire various kinds of data through interactive communications, and store them prior to showing on the screen of remote controller 130. This allows the unit to use interactive communications having a communication speed lower than the bit rate of a motion picture to be exchanged.

On the other hand, using interactive communications with higher speed can provide real-time capture of data. The high-speed communications, for example, Bluetooth, 802.11b, 802.11a, 802.11g, and ZigBee, can save the memory area for data storage in remote controller 130.

As described in the first through third embodiments, the interactive remote control unit of the present invention can offer a viewer various kinds of services, such as an EPG service, and a VOD service, introducing the services not on the TV display but on display 16 of remote controller 10 (130) on hand. The viewer can browse the program guide, and enjoy a program that he/she is interested in by easy operations provided by remote controller 10 (130).

### FOURTH EXEMPLARY EMBODIMENT

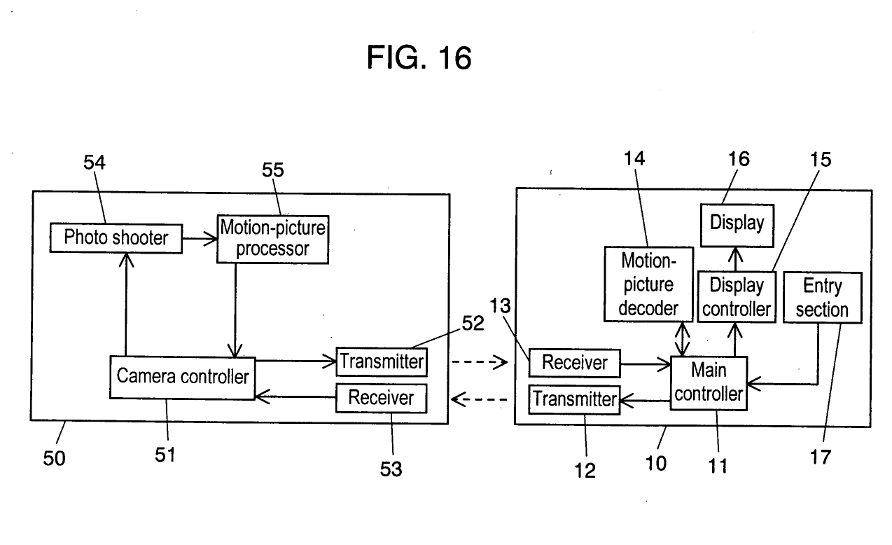

FIG. 16 is a block diagram in the case that the interactive remote control unit of an exemplary embodiment of the present invention is employed for a camera. According to the embodiment, interactive remote control unit (hereinafter, remote controller) 10 controls a device to be controlled, i.e., camera 50 through interactive wireless communications.

The major components of remote controller 10 are: receiver 13 for receiving signals including information on operating condition of camera 50 and photo image; motion-picture decoder (hereinafter, decoder) 14 for decoding the photo image captured at receiver 13; display 16 for showing the operating condition, the photo image, or combinations of both. The rest of the components are the same as those of the first embodiment.

Camera 50 contains i) photo shooter 54 responsible for taking pictures, ii) motion-picture processor 55 for image processing to the pictures handed from photo shooter 54; iii) camera controller 51 for controlling photo shooter 54; iv) transmitter 52 for sending information on operating conditions of camera 50 and the pictures; and v) receiver 53 for receiving information on operations from remote controller 10.

Transmitter 12 of remote controller 10 sends controlling information on, for example, camera angle, zooming, focusing. Remote controller thus operates camera 50. On the other hand, receiver 13 of remote controller 10 receives operating conditions of camera 50 and photo images and shows the conditions, the photo images, or combinations of them on display 16. A user can check camera 50 for settings (camera angle, zooming, etc) through the images on display 16. The user further can send control data via remote controller 10. With the interactive remote control unit, the user can receive, from a distance, information including the setting of camera 50, and also can send another data to control the camera.

Through all the aforementioned embodiments, some components in main controller 11, processor 14, display controller 15, and timer 18 can be integrally formed. As another possible structure, transmitter 12 and receiver 13 can be configured as a one-piece design.

What is claimed is:

1. An interactive remote control unit for controlling a device to be controlled through bi-directional wireless communications, the unit comprising:
a) a receiver for receiving a signal via the device to be controlled;
b) a display for displaying information contents of the signal received at the receiver;
c) an entry section for accepting input data with respect to the information shown on the display;
d) a transmitter for transmitting operation data for the device according to the input data; and
e) a controller for governing the receiver, the display, and the transmitter.

2. The interactive remote control unit as defined in claim 1, wherein in response to a request through the entry section, for selecting specific content among the information contents shown in the display, the display shows details of the content specified.

3. The interactive remote control unit as defined in claim 2, wherein the content shown in the display includes at least any one of a text data, a still image, and a motion picture.

4. The interactive remote control unit as defined in claim 1, wherein the device to be controlled is a digital-broadcasting receiver, and the signal contains program arrangement information required for creating an electronic program guide (EPG).

5. The interactive remote control unit as defined in claim 4, wherein in response to a request through the entry section, for selecting specific content—which includes any one of i) a broadcasting program and ii) information distributed by a video-on-demand service—among the EPG shown in the display, the display shows a motion picture of the content specified.

6. The interactive remote control unit as defined in claim 1, wherein the device to be controlled is a digital-broadcasting receiver, and the signal contains a still image data for an EPG.

7. The interactive remote control unit as defined in claim 6, wherein in response to a request through the entry section, for selecting a broadcasting program from the EPG, the display shows a motion picture of the broadcasting program.

8. The interactive remote control unit as defined in claim 1, wherein the device to be controlled is a digital-broadcasting receiver, and the signal contains information on data-broadcasting program guide.

9. The interactive remote control unit as defined in claim 8, wherein in response to a request through the entry section, for selecting a data-broadcasting program from the data-broadcasting program guide, the display shows a motion picture of the data-broadcasting program.

10. The interactive remote control unit as defined in claim 1, wherein the device to be controlled is a recording/reproducing device, and the signal contains table-of-contents information on motion pictures recorded in a recording medium employed for the recording/reproducing device.

11. The interactive remote control unit as defined in claim 10, wherein in response to a request through the entry section, for selecting an item from the table-of-contents information, the display shows a motion picture corresponding to the item selected.

12. The interactive remote control unit as defined in claim 10, wherein the recording/reproducing device is any one of i) a video cassette recorder; ii) a hard disk video recorder; and iii) an optical disk video recorder.

13. The interactive remote control unit as defined in claim 1, wherein the transmitter and the receiver communicate with the device to be controlled under communication standards of any one of Bluetooth, 802.11b, 802.11a, 802.11g, and ZigBee.

14. The interactive remote control unit as defined in claim 1, wherein the device to be controlled is a camera, and the signal contains at least any one of i) information on operating condition of the camera; and ii) a video signal captured by the camera.

15. The interactive remote control unit as defined in claim 14, wherein in response to a request according to the operating condition and the video signal through the entry section, the remote control unit controls the camera for at least any one of i) determining an angle; ii) zooming; and iii) focusing.

16. The interactive remote control unit as defined in claim 1, wherein the display further shows ads information, with the information contents and the selected content being displayed.

17. The interactive remote control unit as defined in claim 16, wherein the ads information is formed at least any one of i) text information; ii) a still image; and iii) a motion picture.

18. The interactive remote control unit as defined in claim 16, wherein the ads information are displayed any one of on a periodical and a continuous basis.

19. The interactive remote control unit as defined in claim 16, wherein in response to a request entered through the entry section, the display stops showing the ads information.

20. The interactive remote control unit as defined in claim 1, wherein the information contents contain at least any one of no-charge service information and charged service information.

21. The interactive remote control unit as defined in claim 1, wherein the display shows contents data of the information by an operator's action of any one of i) touching the unit; and ii) operating the unit.

22. The interactive remote control unit as defined in claim 21, wherein the information is provided as a video-on-demand service, the display shows at least any one of i) text information, ii) a still image, and iii) a motion picture in order to introduce the contents data.

23. The interactive remote control unit as defined in claim 1, wherein the unit outputs sound so as to correspond to the information contents shown in the display.

24. The interactive remote control unit as defined in claim 23, wherein the unit controls volume of the sound in response to a request entered through the entry section.

25. The interactive remote control unit as defined in claim 21 further includes a timer for obtaining at least any one of i) time elapsed since the display has shown the contents data; and ii) time elapsed since a previous operation on the remote control unit, wherein the controller requests the display, at a conclusion of a predetermined period of time, so as to perform any one of following operations: i) having blanked display; and ii) switching the contents data to different contents data.

26. The interactive remote control unit as defined in claim 1, wherein the entry section includes a touch panel formed on the display section.

27. The interactive remote control unit as defined in claim 21, the display shows details of the contents data in response to a request entered through the entry section.

28. The interactive remote control unit as defined in claim 21, wherein the unit changes information shown in the display without regard to a request entered through the entry section.

29. The interactive remote control unit as defined in claim 1, wherein the display contains a plurality of sub-windows, each of which bears different information.
